(19) United States
(12) Patent Application Publication
(10) Pub. No.: US 2008/0046625 A1
(43) Pub. Date: Feb. 21, 2008

(54) Sensor switching system for a computing device and related methods

(76) Inventors: Robert Spano, Smithtown, NY (US); Michael T. Verdecanna, Bayport, NY (US); Carl Degiovine, Shirley, NY (US); Dean Larosa, Bohemia, NY (US); Amir Weiss, Patchogue, NY (US)

Correspondence Address: FAY KAPLUN & MARCIN, LLP, 15O BROADWAY, SUITE 702, NEW YORK, NY, 10038, US

(21) Appl. No.: 11/506,954

(22) Filed: Aug. 18, 2006

(51) Int. Cl. G06F 13/00

(52) U.S. Cl. 710/302

(57) ABSTRACT

Described is a device comprising a power supply, a receiving arrangement, a removable cover and a sensor. The receiving arrangement detachably receives a peripheral device. The peripheral device draws power from the power supply when coupled to the receiving arrangement. The removable cover covers the receiving arrangement and prevents the peripheral device from being physically removed from the receiving arrangement. The sensor outputs a first signal when the cover covers the receiving arrangement and outputs a second signal when the cover is removed from the receiving arrangement. Communication with the peripheral device is terminated as a function of the first and second signals.

### FIELD OF THE INVENTION

The present invention relates generally to a sensor switch for a computing device and systems and methods related thereto.

### BACKGROUND

During a shut down procedure executed by a computing device, an operating system submits an inquiry to each application running on the computing device as to whether it can be properly shut down. If an application is running and abruptly shut down by the operating system, data being generated, communicated, etc. by the application may be lost and/or corrupted. The applications that receive the inquiry also include drivers for communicating with peripheral devices coupled to the computing device. For example, a wireless card may be removably coupled to the computing device and provide access to a wireless computing network. A driver for the wireless card may receive the inquiry and determine whether the wireless card is actively communicating with the wireless network or with a processor of the computing device. If so the driver may wait until the communication is terminated (or terminates the communication at a predefined point) and then shut itself down. However, because the wireless card is removably coupled to the computing device, a user may remove the wireless card thinking that the communication has been terminated, when, in fact, the communication was still occurring and data was being processed. The removal, along with terminating the communication, may also result in loss and/or corruption of data. Thus, there is a need for mechanism to ensure that a device (and a corresponding application) has been properly shut down.

### SUMMARY OF THE INVENTION

The present invention relates to a sensor switch system for a computing device and methods related thereto. The device comprises a power supply, a receiving arrangement, a removable cover and a sensor. The receiving arrangement detachably receives a peripheral device. The peripheral device draws power from the power supply when coupled to the receiving arrangement. The removable cover covers the receiving arrangement and prevents the peripheral device from being physically removed from the receiving arrangement. The sensor outputs a first signal when the cover covers the receiving arrangement and outputs a second signal when the cover is removed from the receiving arrangement. Communication with the peripheral device is terminated as a function of the first and second signals.

### DESCRIPTION OF THE DRAWINGS

FIG. 1 shows an exemplary embodiment of a system according to the present invention.

FIG. 2 shows an exemplary embodiment of a method according to the present invention.

### DETAILED DESCRIPTION

The present invention may be further understood with reference to the following description and the appended drawings, wherein like elements are referred to with the same reference numerals. The present invention describes a sensor switch for a computing device and related systems and methods. While the exemplary embodiments will be described with reference to the sensor switch being utilized by a mobile computing unit, those of skill in the art will understand that the sensor switch may be utilized on any computing device, mobile or stationary, to enable/terminate communication with a peripheral device coupled thereto.

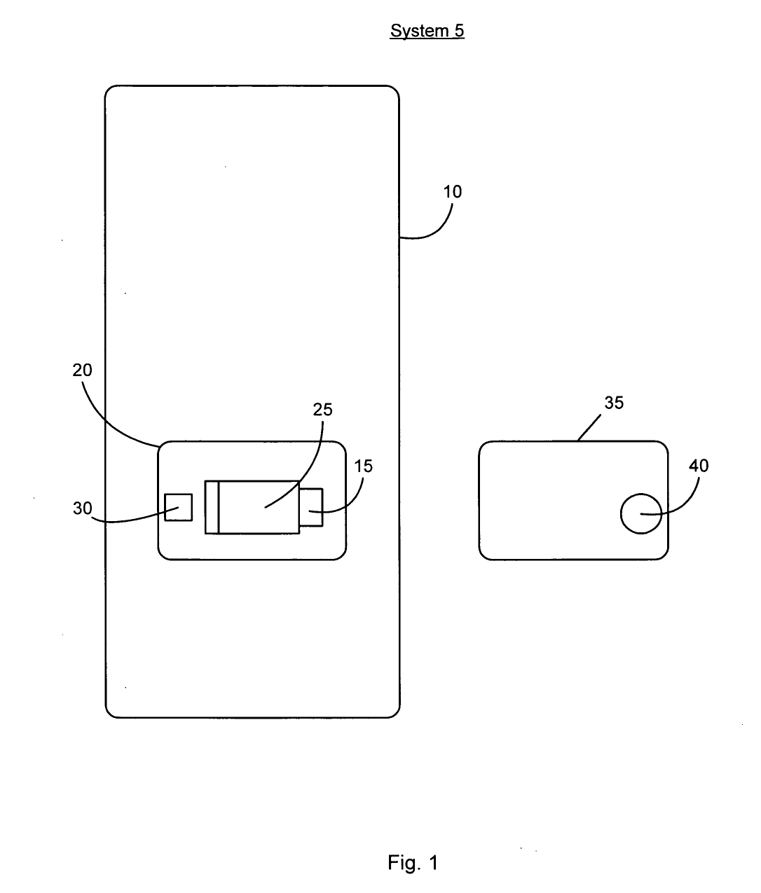

FIG. 1 shows an exemplary embodiment of a system 5 utilizing a sensor switch according to the present invention. The system 5 includes a host computing device and a peripheral device detachably coupled thereto. In the exemplary embodiment, the host computing device is a mobile computing unit (MU) 10 which may include, for example, a laser-/imager-based scanner, an RFID reader, a PDA, a mobile phone, a tablet computer, a laptop, a digital camera, a digital media player, etc. The peripheral device may be a subscriber identify module (SIM) card 15, a flash card, a compact flash (CF) card, a secure digital (SD) card, a network interface card (NIC), a personal computer memory card international associates (PCMCIA) card, an universal serial bus (USB) device, etc. As noted above, the host computing device may be any mobile or stationary computing device and the peripheral device may be any device detachably coupled thereto. As is known in the art, the peripheral device, when coupled to the host computing device, may draw power from a power source (e.g., a battery, line voltage) of the host computing device.

As known by those of skill in the art, the SIM card 15 is a smart card that provides additional functionality to the MU 10 in terms of, for example, wireless communications, storage, additional software, etc. For example, the SIM card 15 may provide encryption capabilities for voice and data transmissions, as well as authentication information identifying a user of the MU 10 to a wireless network. The SIM card 15 may also store user-specific data, e.g., phone/address lists, calendars, documents, images, media files, etc. In this manner, the MU 10 may be used by multiple users for both business and personal activities, a plurality of functions, etc.

The MU 10 communicates with the SIM card 15 using a driver. The driver is a software application which acts like a translator between the MU 10 and the SIM card 15. That is, the SIM card 15 utilizes specialized commands known to it and the driver, whereas an operating system (and other programs) on the MU 10 access peripheral devices, e.g., the SIM card 15, using generic commands. The driver accepts the generic commands and translates them into the specialized commands and vice-versa, allowing the MU 10 to communicate with the SIM card 15.

Referring back to FIG. 1, the MU 10 includes a receiving arrangement 20 for detachably receiving the SIM card 15. The receiving arrangement 20 may include a card slot 25, a sensor switch 30 and a slot cover 35. Those of skill in the art will understand that the receiving arrangement 20 may conform to the peripheral device being detachably receiving thereby. For example, if the peripheral device is a USB device, a corresponding receiving arrangement on the host computing device may include a USB port, instead of the card slot 25. The slot cover 35 may be removably attached to the MU 10, covering the receiving arrangement 20 when coupled to the MU 10. Those of skill in the art will further understand the slot cover 35 may be replaced by a securing arrangement (e.g., a latch) which temporarily affixes the peripheral device to the host computing device. Also, while the exemplary embodiment of FIG. 1 shows the slot cover 35 as a separate piece completely detachable from the MU 10, in other exemplary embodiments the slot cover 35 may be hingedly connected (e.g., as a door) or slidably connected (e.g., as a window) over the receiving arrangement 20.

In the exemplary embodiment, the card slot 25 provides a card receiving position and a card locking position. In the card receiving position, the SIM card 15 may be inserted into and/or removed from the card slot 25. In the card locking position, the card slot 25 ensures that electrical contacts on the SIM card 15 are engaged by complementary electrical contacts on the MU 10. A connection between the electrical contacts and the complementary electrical contacts allows the SIM card 15 and the MU 10 to exchange data, and also allows the SIM card 15 to draw power from a power source (e.g., a battery) of the MU 10.

In the exemplary embodiment, the sensor switch 30 may be a Hall effect sensor which detects a presence/absence of a magnet 40 disposed on an underside of the slot cover 35. As is known in the art, the Hall effect sensor is a transducer which varies its output voltage as a function of changes in magnetic field density. Thus, the output voltage may vary based on whether the slot cover 35 is placed over the receiving arrangement 20, i.e., when the magnet 40 comes within a predetermined distance of the sensor switch 30 as to effect a change in the magnetic field density therearound. In the exemplary embodiment, the sensor switch 30 includes an internal comparator which converts the output voltage into a digital signal, i.e., on/off. A processor (not shown) of the MU 10 may utilize the digital signal to terminate communication with the SIM card 15 and/or selectively provide power to the card slot 25, as will be described further below. In another exemplary embodiment, the output voltage from the sensor switch 30 may be converted into a digital signal by an analog-to-digital converter as is known in the art.

Those of skill in the art will understand that the sensor switch 30 may utilize any mechanical, electrical or electromechanical mechanism(s) for detecting the presence/absence of the slot cover 35. For example, in another exemplary embodiment, the sensor switch 30 may be a two-state button which, when depressed by the slot cover 35 indicates its presence. In a further exemplary embodiment, the presence of the slot cover 35 may complete an electric circuit.

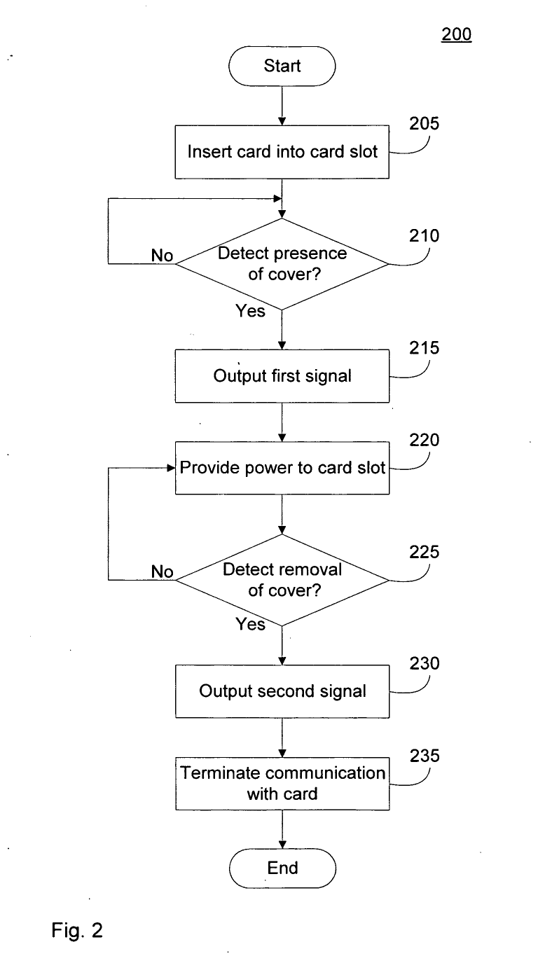

FIG. 2 shows an exemplary embodiment of a method 200 according to the present invention. The exemplary embodiment of the method 200 will be described with reference to a user inserting the SIM card 15 into an empty card slot 25 and then removing the SIM card 15 therefrom. Thus, at an outset of the method 200, the slot cover 35 is removed from the receiving arrangement 20.

In step 205, the SIM card 15 is inserted into the card slot 25. At this point, there is no power provided to the card slot 25, because the sensor switch 30 has not detected the presence of the slot cover 35. As understood by those of skill in the art, even when the sensor switch 30 detects the presence of the slot cover 35, the card slot 25 may not be powered unless the MU 10 itself is powered.

In step 210, the sensor switch 30 determines whether the slot cover 35 has been coupled to the MU 10 over the receiving arrangement 20 by detecting for a presence of the magnet 40. In the exemplary embodiment, a first change in the magnetic field density around the sensor switch 30 may be indicative of the presence of the magnet 40, while a second change may be indicative of an absence of the magnet 40.

In step 215, the sensor switch 30 has detected the presence of the magnet 40, and outputs a first signal. In the exemplary embodiment, the first signal from the sensor switch 30 is a voltage change which the processor of the MU 10 interprets as an indication that the slot cover 35 is secured over the receiving arrangement 20 and that power should be provided to the card slot 25. As noted above, the voltage output by the sensor switch 30 may be converted into a digital signal so that a first digital signal is indicative of the slot cover 35 being secured to the receiving arrangement 20.

In step 220, in response to the first signal, the MU 10 provides power to the card slot 25. Thus, the SIM card 15 may use the power provided to the card slot 25 to read/write data to its memory, exchange data with the MU 10 and execute any other functions alone and/or in combination with the MU 10.

In step 225, the sensor switch 30 determines whether the slot cover 35 has been removed from the receiving arrangement 20 by detecting for an absence of the magnet 40. In the exemplary embodiment, the second change in the magnetic field density around the sensor switch 30 may be indicative of the absence of the magnet 40.

In step 230, the sensor switch 30 has detected the absence of the magnet 40, and outputs a second signal. In the exemplary embodiment, the second signal from the sensor switch 30 is a voltage change which the processor of the MU 10 interprets as an indication that the slot cover 35 has been removed from the receiving arrangement 20. As noted above, the voltage output by the sensor switch 30 into a digital signal so that a second digital signal is indicative of the slot cover 35 being removed from the receiving arrangement 20.

In step 235, in response to the second signal, the MU 10 may terminate the supply of power to the card slot 25. In one exemplary embodiment, the MU 10 may terminate applications executing on its radio transceiver and disable power thereto. The SIM card 15 will be shut down simultaneously or immediately after power is cut to the radio transceiver, because the card slot 25 receives its power through the radio transceiver. In addition, the MU 10 may instruct the SIM card 15 to execute a shut down procedure so that the SIM card 15 properly shuts down before power is removed therefrom. Terminating the power to the card slot 25 may ensure that data on the SIM card 15 and/or the MU 10 will not be lost or corrupted if a user physically removes the SIM card 15 from the card slot 25, severing the electrical connection therebetween. Upon detection of the second signal, the processor on the MU 10 may determine when it is safe to terminate the power to the card slot 25 based on whether, for example, data is being written to and/or accessed by programs on the MU 10, applications on the SIM card 15 are being utilized, etc.

In another exemplary embodiment, an indicator (e.g., an LED) may be disposed adjacent the card slot 25. When the LED is lit, it may indicate to the user that the SIM card 15 is in use and the physical removal thereof would risk loss/corruption of data. The processor on the MU 10 may control the indicator as a function of the output signals from the sensor switch 30.

Those of skill in the art will understand that the exemplary embodiments of the present invention provide advantages in terms of, for example, data integrity, user satisfaction and operating efficiency. With regard to data integrity, as described above, the sensor switch 30 enables the MU 10 to anticipate that the SIM card 15 is going to be removed. By anticipating the removal of the SIM card 15, the MU 10 may instruct the SIM card 15 to execute its shut down procedure which ensures that any data being exchanged and/or processed is not lost or corrupted. The sensing of the removal of the slot cover 35, transmitting the instruction to shut down and/or the termination of the power to the card slot 25 may be performed in a predetermined time period which is preferably less than a time taken for a user of the MU 10 to remove the slot cover 35 from the receiving arrangement 20 and remove the SIM card 15 from the card slot 25.

With regard to user satisfaction and operating efficiency, the exemplary embodiments of the present invention ensure that data on the SIM card 15 is not lost and/or corrupted. It may frustrate the user if the SIM card 15 is later used and does not contain the data that the user expected. Also, if exchange of data between the MU 10 and the SIM card 15 was interrupted, the MU 10 may not be capable of performing a task which requires the data. While frustrating the user, the loss/corruption of data may require re-coupling the SIM card 15 to the MU 10 and re-executing a process. Alternatively, the user may believe that the MU 10 and/or the SIM card 15 is malfunctioning and send either back to a manufacturer for service. Unnecessary service is costly to the user in terms of wasted time.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a power supply;
a receiving arrangement detachably receiving a peripheral device, the peripheral device drawing power from the power supply when coupled to the receiving arrangement;
a removable cover covering the receiving arrangement and preventing the peripheral device from being physically removed from the receiving arrangement; and
a sensor outputting a first signal when the cover covers the receiving arrangement and outputting a second signal when the cover is removed from the receiving arrangement,
wherein communication with the peripheral device is terminated as a function of the first and second signals.

2. The device according to claim 1, wherein the device includes at least one of a laser-based scanner, an imager-based scanner, an RFID reader, a mobile phone, a PDA, a digital camera and a media player.

3. The device according to claim 1, wherein the peripheral device is one of a subscriber identify module (SIM) card, a flash card, a compact flash (CF) card, a secure digital (SD) card, a network interface card (NIC), a personal computer memory card international associates (PCMCIA) card, an universal serial bus (USB) device and a memory stick.

4. The device according to claim 1, wherein the sensor is one of a Hall effect sensor and a two-state button.

5. The device according to claim 4, wherein the cover includes a magnet and the Hall effect sensor generates the first signal in response to a change in a magnetic field surrounding the Hall effect sensor due to a presence of the magnet.

6. The device according to claim 1, wherein the cover is one of a door, a hinged door, a window and a latch.

7. The device according to claim 1, further comprising:
a processor which, upon receipt of the first signal, enables the peripheral device to draw power from the power supply, and, upon receipt of the second signal, terminates the power to the peripheral device from the power supply.

8. A method, comprising:
receiving a peripheral device in a receiving arrangement of a host device, the peripheral device drawing power from a power supply of the host device when received in the receiving arrangement;
detecting, by a sensor of the host device, a presence of a cover for the receiving arrangement, the cover preventing the peripheral device from being physically removed from the receiving arrangement;
outputting, by the sensor, a first signal when the cover covers the receiving arrangement and a second signal when the cover is removed from the receiving arrangement;
providing power from the power supply to the peripheral device as a function of the first and second signals.

9. The method according to claim 8, wherein the host device includes at least one of a laser-based scanner, an imager-based scanner, an RFID reader, a mobile phone, a PDA, a digital camera and a media player.

10. The method according to claim 8, wherein the peripheral device is one of a subscriber identify module (SIM) card, a flash card, a compact flash (CF) card, a secure digital (SD) card, a network interface card (NIC), a personal computer memory card international associates (PCMCIA) card, an universal serial bus (USB) device and a memory stick.

11. The method according to claim 8, wherein the sensor is one of a Hall effect sensor and a two-state button.

12. The method according to claim 8, wherein the cover includes a magnet and the method further comprises:
generating, by the Hall effect sensor, the first signal in response to a change in a magnetic field surrounding the Hall effect sensor due to a presence of the magnet.

13. The method according to claim 8, wherein the cover is one of a door, a hinged door, a window and a latch.

14. The method according to claim 8, wherein the providing step includes the following substep:
upon receipt of the first signal by the host device, enabling the peripheral device to draw power from the power supply.

15. The method according to claim 8, wherein the providing step includes the following substep:
upon receipt of the second signal by the host device, terminating the power to the peripheral device from the power supply.

16. A device, comprising:
a receiving arrangement detachably receiving a peripheral device;
a removable cover covering the receiving arrangement; and
a sensor outputting a first signal upon detecting a coupling of the cover to the receiving arrangement and outputting a second signal upon detecting a removal of the cover from the receiving arrangement.

17. The device according to claim 16, further comprising:
a processor selectively providing power to the peripheral device as a function of the first and second signals.

18. The device according to claim 17, wherein, upon receipt of the first signal, the processor supplies power to the peripheral device.

19. The device according to claim 17, wherein, upon receipt of the second signal, the processor terminates power to the peripheral device.

20. A device, comprising:
a power supply means;
a receiving means for detachably receiving a peripheral device, the peripheral device drawing power from the power supply means when coupled to the receiving means;
a removable cover means covering the receiving means and preventing the peripheral device from being physically removed from the receiving means; and
a sensor means for outputting a first signal when the cover means covers the receiving means and outputting a second signal when the cover means is removed from the receiving means,
wherein communication with the peripheral device is terminated as a function of the first and second signals.
